(19) United States
(12) Patent Application Publication
(10) Pub. No.: US 2006/0014954 A1
(43) Pub. Date: Jan. 19, 2006

(54) Microporous structure of an organic metal complex

(75) Inventor: Taihei Mukaide, Kanagawa (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 10/533,454

(22) PCT Filed: Dec. 26, 2003
(86) PCT No.: PCT/JP03/16933

§ 371 Date: May 2, 2005

(30) Foreign Application Priority Data
Jan. 7, 2003 (JP) 2003-001208
Dec. 19, 2003 (JP) 2003-422958

(51) Int. Cl. C07F 15/00

(52) U.S. Cl. 546/2; 548/102; 549/2; 556/136

(57) ABSTRACT

A porous structure includes an organic metal complex represented by the following general formula (1):
M·L(A,B)₃ (1) (where M represents a metal atom; L (A, B) represents a ligand constituted of A and B; and A and B respectively represent cyclic groups which may have or may not have one or more substituents).

### TECHNICAL FIELD

The present invention relates to a technical field of a zeolite which is a porous body, and more particularly to a microporous structure (organic zeolite) made of an organic metal complex.

### BACKGROUND ART

In recent years, various porous materials have attracted attention. The porous body is classified into three types: a microporous body having a pore size of 2 nm or less; a mesoporous body having a pore size of 2 to 50 nm; and a macroporous body having a pore size of 50 nm or more. A zeolite belonging to the microporous body is a porous crystalline aluminosilicate formed from a three-dimensional mesh structure of a TO₄ tetrahedral body (where T represents silicon or aluminum). Further, recently, an organic zeolite having pores formed by a network of an organic compound containing a metal has attracted attention. The organic zeolite generally has a lower density than that of the zeolite. Accordingly, the organic zeolite is a lightweight material and can be readily recovered or reused using a solvent. Thus, as a high-performance material substitutive for the zeolite, the organic zeolite has been highly expected as being capable of applying to a gas storage material, a gas sensor, or the like.

### DISCLOSURE OF THE INVENTION

The present invention provides a microporous structure including an organic metal complex molecule, containing a metal atom in its center.

More specifically, the present invention provides a porous structure comprising an organic metal complex represented by the following general formula (1):
M·L(A,B)₃ (1)
(where M represents a metal atom; L (A, B) represents a ligand comprised of A and B; and A and B respectively represent cyclic groups which may have or may not have one or more substituents).

Further, the present invention provides a porous structure as mentioned above, in which the general formula (1) is represented by the general formula (2): 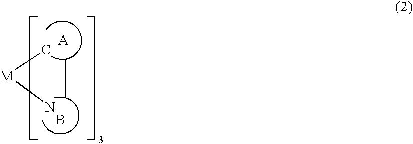
(where M represents a metal atom; A and B respectively represent cyclic groups which may have or may not have one or more substituents, in which the substituent is a halogen atom, a nitro group, a trialkylsilyl group (in which alkyl groups are linear or branched alkyl groups having 1 to 8 carbon atom(s) independently of one another), or a linear or branched alkyl group having 1 to 20 carbon atom(s) (in which one methylene group or two or more methylene groups not adjacent to each other in the alkyl group may be substituted for —O—, —S—, —CO—, —CO—O—, —O—CO—, —CH═CH— or —C≡C—, and a hydrogen atom in the alkyl group may be substituted for a fluorine atom)).

The present invention provides a porous structure as mentioned above, characterized in that the porous structure has a three-dimensional structure of a facial isomer represented as the following structure.

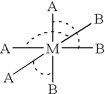

The present invention provides a porous structure as mentioned above, in which at least one of the cyclic groups A and B bonded to the metal atom M in the general formula (1) is one selected from the group consisting of pyridine, pyrimidine, pyrazoline, pyrrole, pyrazole, quinoline, isoquinoline, imidazole, quinone, benzoazepin, catechol, phenol, phenyl, naphthyl, thienyl, benzothienyl, quinolyl, phenothiazine, benzothiazole, benzoxazole, and benzoimidazole.

The present invention provides a porous structure as mentioned above, in which the metal atom M in the general formula (1) is Ir.

The present invention provides a method of manufacturing a porous structure, characterized by including: a step of dissolving an organic metal complex represented by the general formula (1) in a solvent to obtain a solution; a step of precipitating the organic metal complex from the solution to form the porous structure; and a step of removing the solvent in the porous structure.

### BRIEF DESCRIPTION OF THE DRAWINGS

FIG. 1 is a diagram showing a three-dimensional structure of iridium (III) tris(1-phenylisoquinoline) given by a single crystal X-ray structure analysis.

FIG. 2 is a diagram showing an arrangement of iridium (III) tris(1-phenylisoquinoline) in a unit lattice.

FIG. 3 is a diagram showing an arrangement of iridium (III) tris(1-phenylisoquinoline) in a unit lattice.

FIG. 4 is a diagram showing an arrangement of iridium (III) tris(1-phenylisoquinoline) in arranged unit lattices.

FIG. 5 is a diagram showing a powder X-ray diffraction pattern of iridium (III) tris(1-phenylisoquinoline).

FIG. 6 is a diagram showing a powder X-ray diffraction pattern of iridium (III) tris(1-phenylisoquinoline) at room temperature and at a high temperature.

### BEST MODE FOR CARRYING OUT THE INVENTION

The present invention will be described in detail hereinafter.

A synthesis procedure of an organic metal complex compound represented by the above general formula (2) and used in the present invention is shown below using an iridium complex compound as an example.
Synthesis of a ligand L (reference document: Kevin R. et al., Org. Lett., 1999, 1, 553-556): 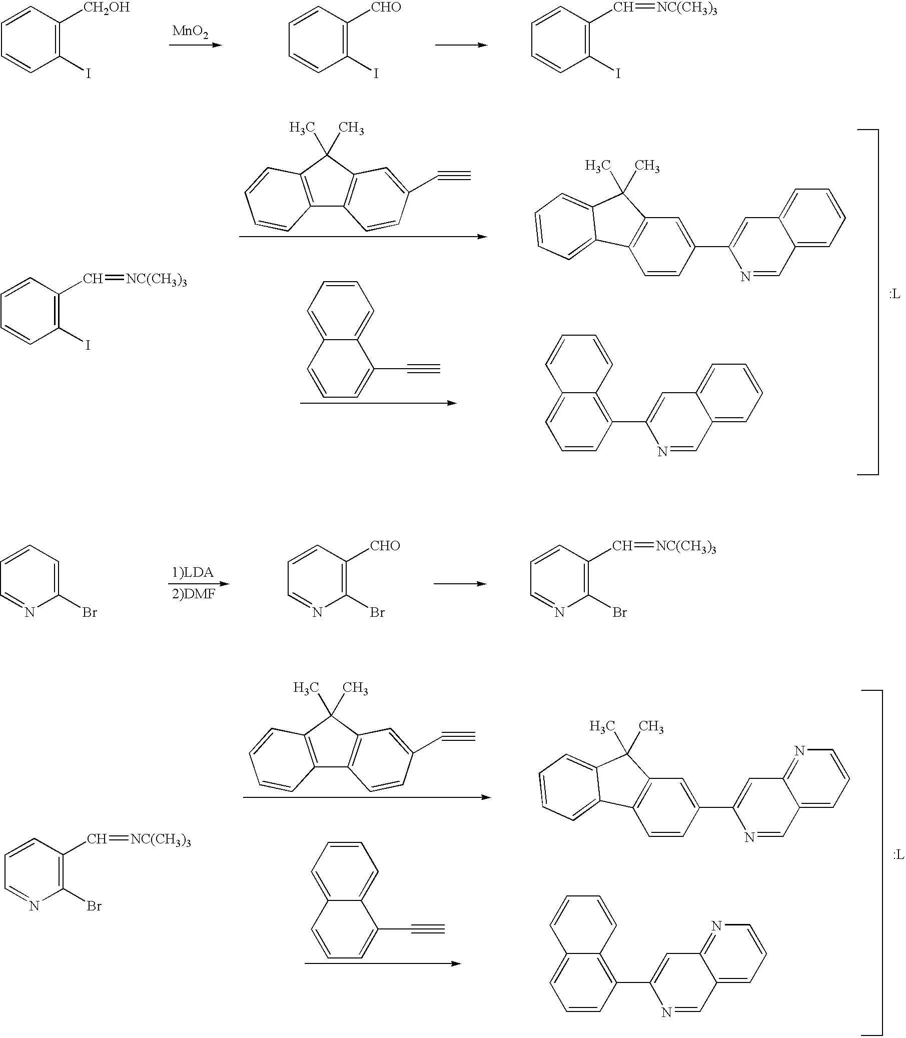
Synthesis of an Iridium Ligand Compound:

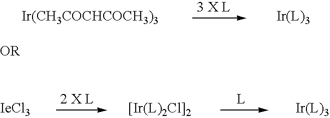

The obtained compound was dissolved in a solvent and then precipitated, to yield a porous structure. In examples, a single crystal X-ray diffraction was conducted using RINT-RAPID, manufactured by Rigaku Denki Co. A pore size was obtained from the crystal structure analysis and powder X-ray diffraction determination was conducted using X′ Pert-PRO, manufactured by Philips Co.

### EXAMPLE

An organic metal complex compound represented by the general formula (1) where A represents a phenyl group and B represents an isoquinoline group, was synthesized in the following procedure.

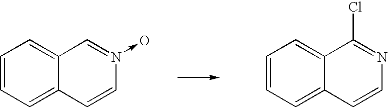

69.3 g of isoquinoline N-oxide (448 mmole) available from Tokyo Kasei Co. and 225 ml of chloroform were introduced into a 1 L-three-neck flask to dissolve therein. Then, 219.6 g (1432 mmole) of phosphorous oxychloride was slowly dropped therein and stirred under ice-cooling while maintaining the inner temperature at 15 to 20° C. Thereafter, the temperature was raised, and the mixture was stirred under reflux for 3 hours. The reaction product was left to cool to room temperature, followed by pouring the resultant into an ice water. The mixture was extracted with ethyl acetate, an organic layer was washed with water till it showed neutral pH, and then the solvent was removed under reduced pressure. The residue was purified using silica gel column chromatography (eluent: chloroform/hexane: 5/1), to yield 35.5 g of a white crystal of 1-chloroisoquinoline (44.9% yield).

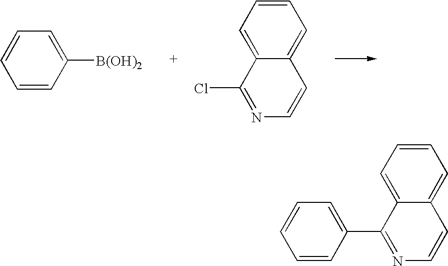

3.04 g of phenylboronic acid (24.9 mmole) and 4.09 g of 1-chloroisoquinoline (25.0 mmole), 25 ml of toluene, 12.5 ml of ethanol, and 25 ml of 2M-sodium carbonate aqueous solution were introduced into a 100 ml-three-neck flask. With stirring at room temperature under a nitrogen gas flow, 0.98 g (0.85 mmole) of tetrakis-(triphenylphosphine) palladium (0) was added to the mixture. Thereafter, the resultant was stirred under reflux under a nitrogen gas flow for 8 hours. After the reaction, the reaction product was cooled, and then added with ice water and toluene to extract the organic layer. The organic layer was washed with saline and dried with magnesium sulfate, and then the solvent was removed under reduced pressure. The residue was purified using silica gel column chromatography (eluent: chloroform/methanol: 10/1), to yield 2.20 g of 1-phenylisoquinoline (43.0%

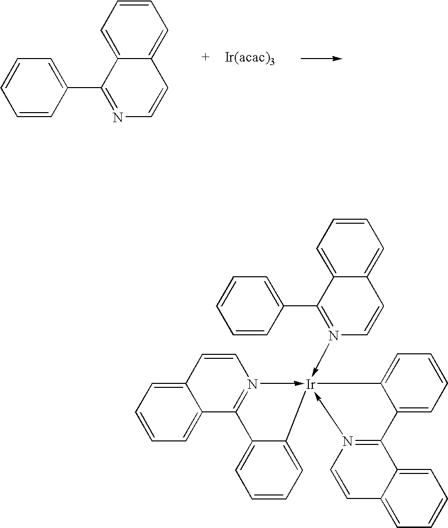

50 ml of glycerol was introduced into a 100 ml-four-neck flask, and then stirred and heated at 130 to 140° C. for 2 hours with bubbling a nitrogen gas. The glycerol was left to cool to 100° C., and then added with 1.03 g (5.02 mmole) of 1-phenylisoquinoline and 0.50 g (1.02 mmole) of iridium (III) acetylacetonate. The reaction mixture was stirred and heated for 7 hours at around 210° C. under the nitrogen gas flow. After being left to cool to room temperature, the reaction product was added to 300 ml of 1N-hydrochloric acid, and the precipitate was filtrated and then washed with water. The precipitate was purified using silica gel column chromatography with chloroform used as an eluent, to yield 0.22 g of a red powder of iridium (III) tris(1-phenylisoquinoline) (26.8% yield).

For preparing a single crystal, 1.5 mg of purified iridium (III) tris(1-phenylisoquinoline) powder was first dissolved in 15 ml of chloroform at room temperature. Then, ethanol was poured till saturation, and the solution was filtrated to obtain a saturated solution. The solvent in the saturated solution was evaporated gently under an isothermal condition, to yield a single crystal in the form of red needle crystal. A sample obtained by drying at 100° C. for 3 hours was used for a single crystal X-ray structure analysis. The single crystal X-ray structure analysis was conducted as follows: the single crystal in liquid paraffin was scooped up with a sample fixing element, and measured while being cooled to 100 K with cooled nitrogen. The crystal structure data obtained by the single crystal X-ray structure analysis is shown in Tables 1 to 3. Parameters shown in the tables are represented in units generally adopted by those skilled in the art. Those units are described in more detail in the following document: International Tables for X-ray Crystallography, Vol. IV, pp. 55, 99, 149.

TABLE 1
Single crystal X-ray structure analysis of iridium (III)
tris(1-phenylisoquinoline) (crystal parameters)

| | |
|---|---|
| Crystal size(mm) | 0.05 × 0.05 × 0.05 |
| Unit lattice size (Å) | a = 16.4781(7) Å |
| | b = 16.4781(7) Å |
| | c = 15.9151(8) Å |
| | α = 90° |
| | β = 90° |
| | γ = 120° |
| | V = 3742.4(3) Å³ |
| Space group | P-3c1 |
| Molecular/Unit lattice | Trigonal system 4 |
| Calculated density(g/cm³) | 1.429 |

TABLE 2
Atomic coordinates and isotropic temperature factor (Å²)

| Atom | x | y | z | Beq |
|---|---|---|---|---|
| Ir(1) | 0.6667 | 0.3333 | 0.38699(2) | 1.109(5) |
| N(1) | 0.6162(4) | 0.2081(3) | 0.4593(3) | 1.26(9) |
| C(1) | 0.5589(4) | 0.1861(4) | 0.5284(4) | 1.4(1) |
| C(2) | 0.5388(4) | 0.1127(4) | 0.5793(4) | 1.5(1) |
| C(3) | 0.5867(4) | 0.0615(5) | 0.5672(4) | 1.7(1) |
| C(4) | 0.5773(5) | −0.0095(5) | 0.6248(4) | 2.0(1) |
| C(5) | 0.6304(5) | −0.0508(5) | 0.6155(4) | 2.4(1) |
| C(6) | 0.6963(5) | −0.0234(5) | 0.5511(5) | 2.2(1) |
| C(7) | 0.7062(5) | 0.0439(5) | 0.4929(4) | 1.9(1) |
| C(8) | 0.6480(4) | 0.0847(4) | 0.4976(4) | 1.7(1) |
| C(9) | 0.6527(4) | 0.1541(4) | 0.4389(4) | 1.4(1) |
| C(10) | 0.7001(4) | 0.1773(4) | 0.3560(4) | 1.4(1) |
| C(11) | 0.7189(4) | 0.1154(4) | 0.3105(4) | 1.5(1) |
| C(12) | 0.7640(5) | 0.1433(5) | 0.2334(4) | 1.7(1) |
| C(13) | 0.7895(5) | 0.2306(5) | 0.2007(3) | 1.6(1) |
| C(14) | 0.7650(4) | 0.2898(4) | 0.2428(4) | 1.4(1) |
| C(15) | 0.7178(5) | 0.2643(5) | 0.3219(4) | 1.6(1) |
| H(1) | 0.5330(4) | 0.2247(4) | 0.5414(4) | 1.6(2) |
| H(2) | 0.4932(4) | 0.0953(4) | 0.6224(4) | 1.6(2) |
| H(3) | 0.5339(5) | −0.0276(5) | 0.6698(4) | 2.3(2) |
| H(4) | 0.6222(5) | −0.0987(5) | 0.6536(4) | 2.8(2) |
| H(5) | 0.7350(5) | −0.0508(5) | 0.5472(5) | 2.8(2) |
| H(6) | 0.7518(5) | 0.0628(5) | 0.4496(4) | 2.3(2) |
| H(7) | 0.7016(4) | 0.0556(4) | 0.3331(4) | 1.7(2) |
| H(8) | 0.7764(5) | 0.1014(5) | 0.2025(4) | 2.1(2) |
| H(9) | 0.8252(5) | 0.2514(5) | 0.1504(3) | 1.9(2) |
| H(10) | 0.7788(4) | 0.3479(4) | 0.2182(4) | 1.7(1) |

TABLE 3
Anisotropic temperature factor (Å²)

| Atom | U11 | U22 | U33 | U12 | U13 | U23 |
|---|---|---|---|---|---|---|
| Ir(1) | 0.0158(1) | 0.0158(1) | 0.0106(1) | 0.00790(6) | 0.0000 | 0.0000 |
| N(1) | 0.017(3) | 0.016(2) | 0.015(2) | 0.009(2) | −0.004(2) | −0.006(2) |
| C(1) | 0.019(3) | 0.016(3) | 0.016(3) | 0.007(2) | −0.002(2) | −0.002(2) |
| C(2) | 0.016(3) | 0.019(3) | 0.016(2) | 0.005(2) | 0.000(2) | −0.001(2) |
| C(3) | 0.016(3) | 0.021(3) | 0.024(3) | 0.006(3) | −0.001(3) | 0.001(3) |
| C(4) | 0.027(3) | 0.024(3) | 0.022(3) | 0.011(3) | 0.004(3) | 0.004(3) |
| C(5) | 0.034(4) | 0.024(3) | 0.029(3) | 0.011(3) | 0.001(3) | 0.004(3) |
| C(6) | 0.038(4) | 0.023(3) | 0.029(3) | 0.019(3) | −0.003(3) | 0.003(3) |
| C(7) | 0.022(3) | 0.026(3) | 0.024(3) | 0.012(3) | 0.001(3) | 0.001(3) |
| C(8) | 0.018(3) | 0.017(3) | 0.022(3) | 0.003(2) | −0.002(3) | 0.004(3) |
| C(9) | 0.020(3) | 0.016(3) | 0.017(3) | 0.007(2) | −0.004(2) | 0.001(2) |
| C(10) | 0.019(3) | 0.020(3) | 0.013(2) | 0.008(3) | 0.002(2) | −0.000(2) |
| C(11) | 0.020(3) | 0.016(3) | 0.018(3) | 0.008(2) | −0.003(2) | −0.003(2) |
| C(12) | 0.024(3) | 0.024(3) | 0.019(3) | 0.014(3) | 0.002(3) | −0.005(3) |
| C(13) | 0.021(4) | 0.025(4) | 0.014(2) | 0.011(3) | 0.002(3) | 0.000(3) |
| C(14) | 0.020(3) | 0.021(3) | 0.012(2) | 0.010(2) | −0.005(2) | −0.002(2) |
| C(15) | 0.020(4) | 0.026(4) | 0.019(2) | 0.014(3) | 0.000(3) | 0.003(3) |

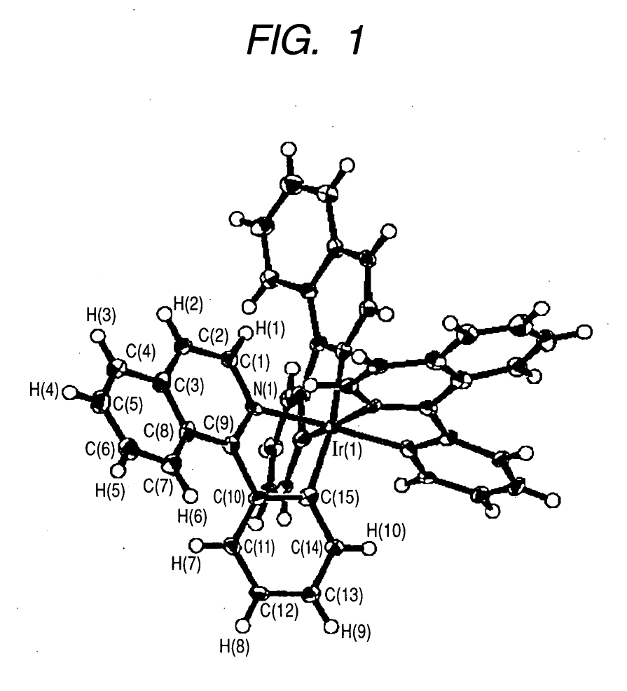

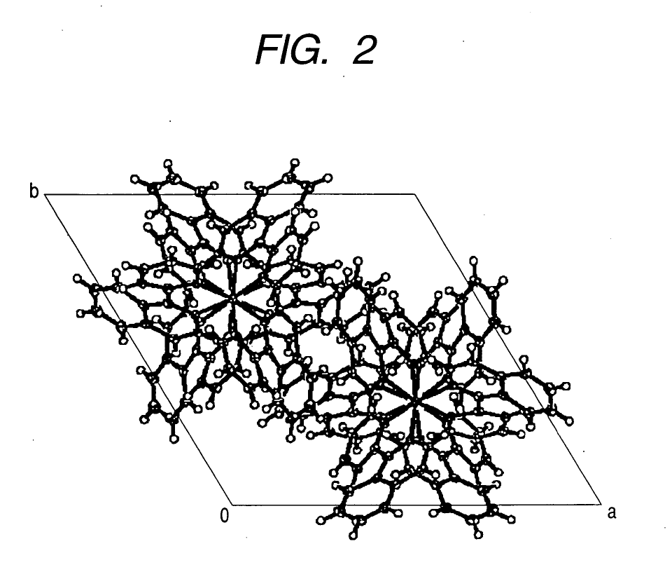

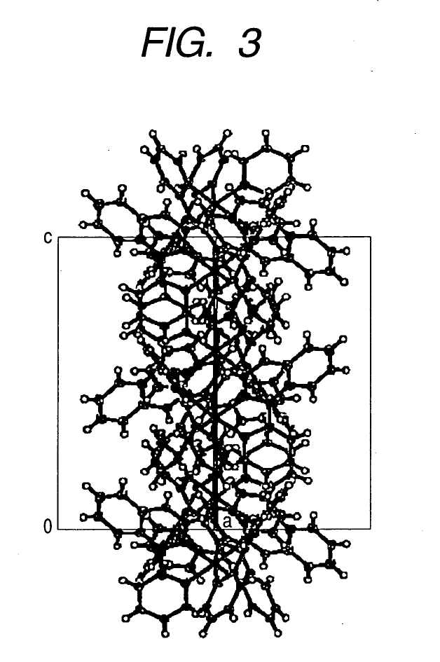

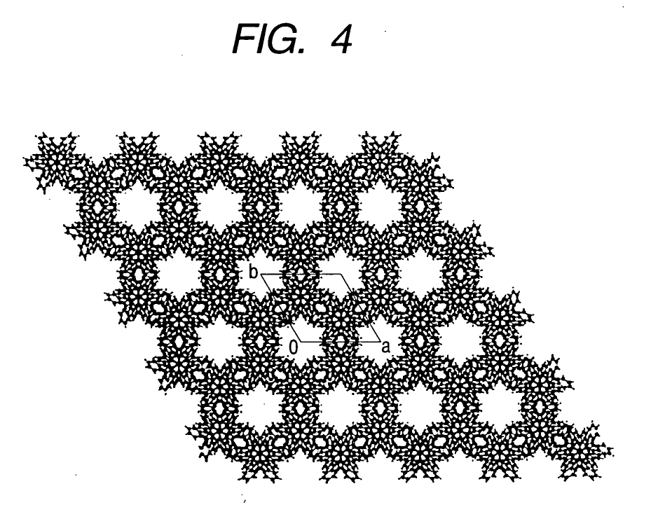

FIG. 1 to FIG. 4 are diagrams where the atomic coordinates obtained by the X-ray structure analysis shown in Tables 1 to 3 are plotted. As apparent from FIG. 1, iridium (III) tris(1-phenylisoquinoline) was a facial isomer. FIG. 4 is a diagram showing a structure of the unit lattices arranged. As apparent from FIG. 4, pore structures existed regulatively in the crystal structure. The pore size was approximately 8 Å, and the calculated porosity was about 21%.

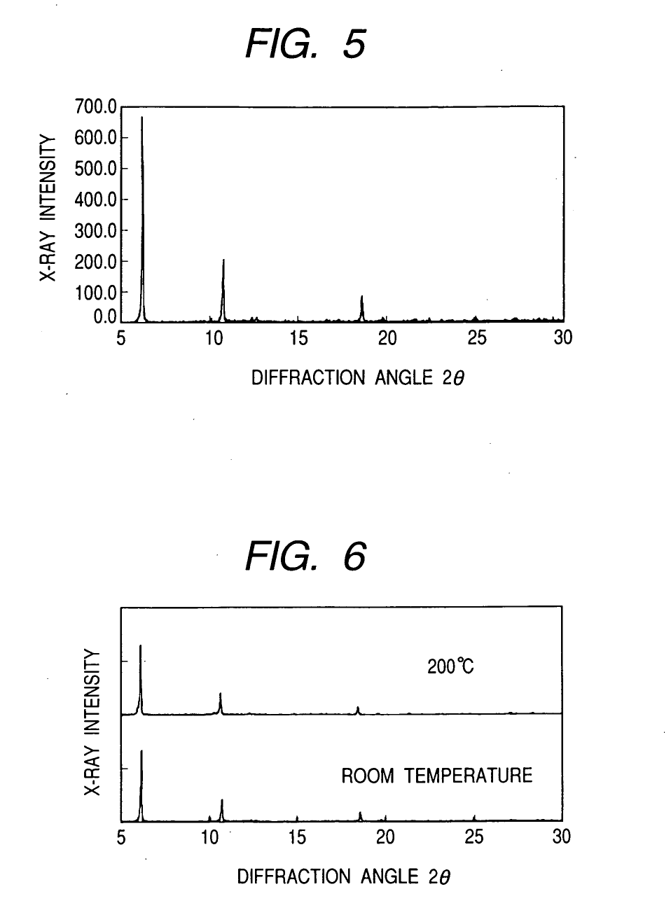

The red powder of iridium (III) tris(1-phenylisoquinoline) dried at 100° C. for 3 hours was subjected to the determination by the powder X-ray diffraction method. The powder X-ray diffraction data is shown in FIG. 5. It was confirmed from the obtained diffraction peak that the crystal structure of the powder was similar to that of the single crystal. To obtain the knowledge about a thermal stability of iridium (III) tris(1-phenylisoquinoline), the red powder of iridium (III) tris(1-phenylisoquinoline) dried for 3 hours was subjected to a determination of in-situ observation at around 200° C. by a high-temperature X-ray diffraction method. FIG. 6 shows powder X-ray diffraction data obtained at room temperature and 200° C. As shown in FIG. 6, the structure was kept stable even at 200° C.

The substance of the above zeolite structure was considered to have functions such as selective capture and permeation of substances, thereby achieving functions of a separation material, a storage material, etc. Moreover, by arranging specific substances in pores of the zeolite, it is possible to develop a new optical/magnetic/electronic material, which expresses specific optical/magnetic/electronic characteristics.

1. A porous structure comprising an organic metal complex represented by the following general formula (1):
M·L(A,B)₃ (1)
(where M represents a metal atom; L (A, B) represents a ligand comprised of A and B; and A and B respectively represent cyclic groups which may have or may not have one or more substituents).

2. A porous structure according to claim 1, wherein the general formula (1) is represented by the general formula (2): 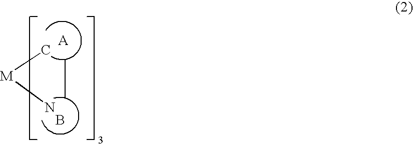
(where M represents a metal atom; A and B respectively represent cyclic groups which may have or may not have one or more substituents, in which the substituent is a halogen atom, a nitro group, a trialkylsilyl group (in which alkyl groups are linear or branched alkyl groups having 1 to 8 carbon atom(s) independently of one another), or a linear or branched alkyl group having 1 to 20 carbon atom(s) (in which one methylene group or two or more methylene groups not adjacent to each other in the alkyl group may be substituted for —O—, —S—, —CO—, —CO—O—, —O—CO—, —CH═CH— or —C≡C—, and a hydrogen atom in the alkyl group may be substituted for a fluorine atom)).

3. A porous structure according to claim 1, wherein the porous structure has a three-dimensional structure of a facial isomer represented as the following structure.

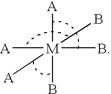

4. A porous structure according to claim 1, wherein at least one of the cyclic groups A and B bonded to the metal atom M in the general formula (1) is one selected from the group consisting of pyridine, pyrimidine, pyrazoline, pyrrole, pyrazole, quinoline, isoquinoline, imidazole, quinone, benzoazepin, catechol, phenol, phenyl, naphthyl, thienyl, benzothienyl, quinolyl, phenothiazine, benzothiazole, benzoxazole, and benzoimidazole.

5. A porous structure according to claim 1, wherein the metal atom M in the general formula (1) is Ir.

6. A method of manufacturing a porous structure, characterized by comprising: a step of dissolving an organic metal complex represented by the general formula (1) in a solvent to obtain a solution; a step of precipitating the organic metal complex from the solution to form the porous structure; and a step of removing the solvent in the porous structure:
M·L(A,B)₃ (1)
(where M represents a metal atom; L (A, B) represents a ligand comprised of A and B; and A and B respectively represent cyclic groups which may have or may not have one or more substituents).
